(19) United States
(12) Patent Application Publication
(10) Pub. No.: US 2022/0053975 A1
(43) Pub. Date: Feb. 24, 2022

(54) DISPOSABLE SMOKE ROASTING DEVICE

(71) Applicant: Combustion, LLC, Seattle, WA (US)

(72) Inventor: Christopher Charles Young, Seattle, WA (US)

(21) Appl. No.: 17/408,150

(22) Filed: Aug. 20, 2021

Related U.S. Application Data
(60) Provisional application No. 63/068,822, filed on Aug. 21, 2020.

(51) Int. Cl. A47J 37/07

(52) U.S. Cl. CPC A47J 37/0768; A47J 2202/00; A47J 37/0754; A47J 37/0718

(57) ABSTRACT

One or more implementations of the present disclosure relate to a reusable or disposable outdoor wood or charcoal-fired cooking device. In at least some implementations, embodiments of the present disclosure include one or more of a cooking vessel, a fuel cartridge of combustible fuel (e.g., wood, charcoal) that is positionable within the cooking device, and a control device that includes or controls the operation of a fan, which in turn precisely controls the combustion of the fuel and the conditions within the cooking vessel. The fan may be operative to push or pull air through the fuel cartridge. When the fan is turned off or at low speed, the combustion gases from the fuel cartridge may be vented directly to the ambient environment without passing through the cooking vessel. The cooking vessel and fuel cartridge may be made from materials that are disposable, and ideally recyclable and/or compostable.

### BACKGROUND

### Technical Field

The present disclosure relates to a disposable outdoor wood or charcoal-fired cooking device. In at least some implementations, embodiments of the present disclosure include one or more of a cooking vessel, a fuel cartridge of combustible fuel, and a control device.

### Description of the Related Art

Barbecuing is a cooking method that is usually done outdoors by smoking or otherwise cooking meat or other food with heat generated by combusting wood or charcoal. Generally, barbequing involves cooking meat or other type of food at relatively low temperatures and for relatively long cooking times (e.g., several hours). This is opposed to grilling, which is normally done at high-temperatures directly over combusting fuel for a relatively short time (e.g., a few minutes).

One of the challenges of these various types of cooking methods is temperature control. For example, in some barbecue devices (“smokers”), the temperature inside the cooking chamber may vary by tens of degrees (e.g., 20 degrees, 50 degrees) over the duration of a cooking process, which may be undesirable as that subjects the meat to sub-optimal cooking temperatures that lead to inconsistent results. Another issue with these types of cooking methods is fuel inefficiency. Often, a vast majority of the energy produced by the combusting fuel (e.g., wood, charcoal) is lost as waste heat. Yet another challenge associated with these types of cooking methods relates to the amount of effort required to maintain and clean interior and exterior components of the cooking devices, which may become soiled with various material such as ash, creosote and other smoke residue that is difficult to remove, food by-products (e.g., grease), marinades, environmental debris, etc.

Thus, the inventor of the present disclosure has identified a need for systems and methods that solve some or all of the aforementioned issues with currently available cooking devices.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape or functional arrangement of the particular elements, and may have been solely selected for ease of recognition in the drawings.

FIG. 1 is a partially exploded view of a disposable smoke roasting device, according to one illustrated implementation.

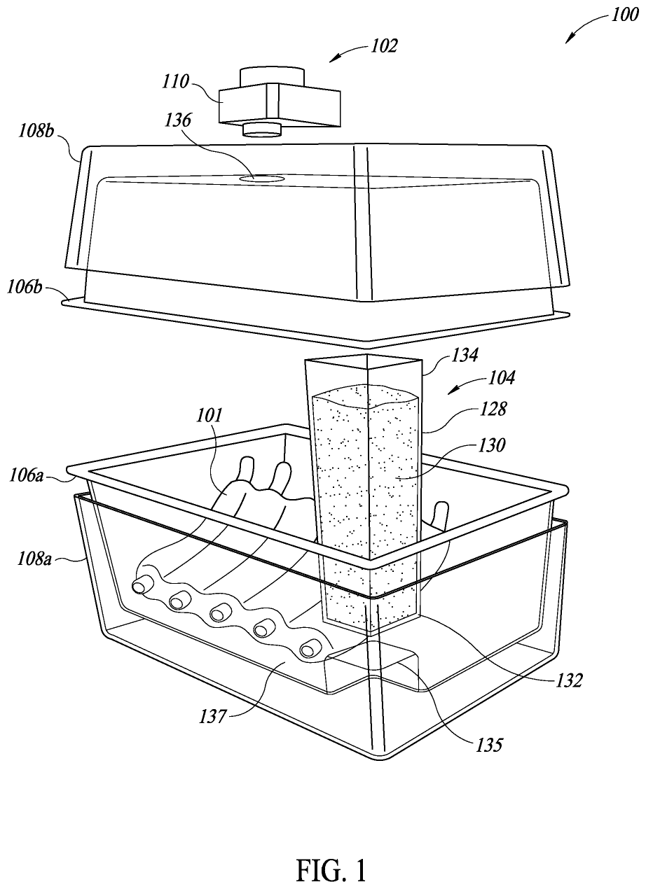

FIG. 2 is a top perspective view of the disposable smoke roasting device, according to one illustrated implementation.

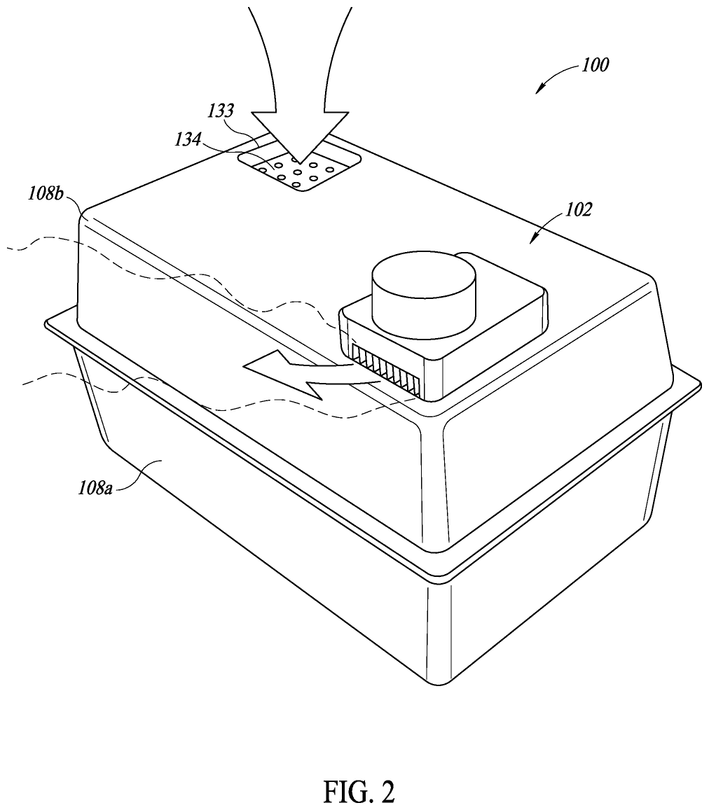

FIG. 3 is a sectional view of the disposable smoke roasting device, illustrating operation when a fan of the disposable smoke roasting device is running fast enough to increase the temperature inside a cooking chamber of the disposable smoke roasting device.

FIG. 4 is a sectional view of the disposable smoke roasting device, illustrating operation when the fan of the disposable smoke roasting device is running slowly or is turned off to maintain or decrease the temperature inside the cooking chamber of the disposable smoke roasting device.

FIG. 5 is a sectional view of a control unit of the disposable smoke roasting device that shows a battery compartment, fan blade, fan volute, motor, and motor mount of the control unit.

FIG. 6 is a bottom view of the control unit of the disposable smoke roasting device that shows the fan blade inside the fan volute housing of the disposable smoke roasting device.

FIG. 7 is a sectional view of a portion of the fan volute of the disposable smoke roasting device, showing air flow within and out of the fan volute.

FIGS. 8A-8E are sectional views of the disposable smoke roasting device, illustrating various example fuel cartridge configurations and fan configurations of the smoke roasting device.

FIG. 9 is a block diagram of the control unit of the disposable smoke roasting device that shows the various example components thereof, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure relate to a disposable outdoor wood or charcoal-fired cooking device. In at least some implementations, embodiments of the present disclosure include one or more of a cooking vessel, a fuel cartridge of combustible fuel (e.g., wood, charcoal, both wood and charcoal), and a control device. One or both of the cooking vessel and the fuel cartridge may be made from materials that are disposable, and ideally recyclable and/or compostable. Advantageously, this feature affords the end-user the convenience of being able to clean-up by disposing of all of the system components except for the reusable control device. However, it should be appreciated that in at least some implementations, some or all of the components of any of the cooking devices discussed herein may be reusable (i.e., non-disposable).

The novel approach to combustion control affords the embodiments discussed herein superior temperature control and significantly greater fuel-efficiency for cooking food by the combustion of wood, charcoal, or other suitable biomass materials. Embodiments of the present disclosure may be suitable for barbecuing, smoking, roasting, or baking foods using wood, charcoal, other suitable biomass materials, or any combinations thereof.

Referring to the Figures, in at least some implementations, a cooking device 100 may include one or more of a control device 102, also referred to herein as a controller or control unit, a combustible fuel-fired fuel cartridge 104, a cooking vessel 106, and an outer shell 108. Each of these components is discussed in detail below.

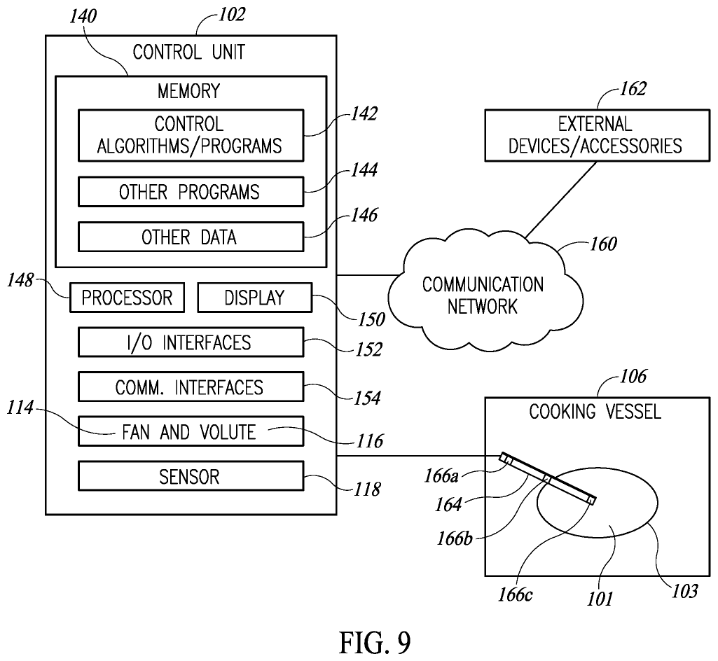

The controller 102 may comprise a reusable housing 110 that includes one or more of a motor 112 (e.g., DC motor) connected to a fan 114, one or more temperature sensors 118 (e.g., thermistor(s)) or other types of sensors, a circuit board assembly 120 that includes control circuitry (e.g., one or more microcontrollers, processors, memory, circuits, etc.), a battery compartment 122, one or more batteries 124, I/O components 126, which may include various inputs, outputs, communications interfaces, etc., such as temperature-input control (e.g., knob, button, touchscreen, wired/wireless interface), an output display, speaker, buzzer, etc. Various example components of the control unit are discussed below with reference to FIG. 9.

The controller 102 may be powered by either one or more batteries 124 and/or externally supplied power. More generally, the controller 102 may be powered by any suitable power source (e.g., batteries, solar cells, AC mains, combinations thereof, etc.). The fan speed is commanded by a control algorithm that takes at least one temperature measurement from inside the cooking vessel, e.g., obtained from the one or more temperature sensors 118, and at least one target temperature set-point as inputs. The target temperature set-point may be set manually via input from a user, or may be set automatically via a control algorithm or program executed by the controller 102. The temperature set-point may be static or dynamic depending on the particular application and preference of the user. As an example, the user may input one or more characteristics of a food product (e.g., type, weight, doneness, texture, initial temperature), and the control unit 102 may automatically determine the static or dynamic temperature set-point based on such input.

As discussed further below, the fan 114 is designed to draw air in from within the cooking vessel 106 and then recirculate a portion of this air into the cooking vessel and eject another portion of the air into the ambient environment. The fraction of air that is recirculated relative to the fraction that is ejected is determined by the speed of the fan 114, and thus the velocity and pressure of fan exhaust. At low-speeds, most of the air is recirculated, while at high speeds a greater fraction of the air is exhausted into the outside environment.

The recirculation of air drives forced convection within the cooking environment. While the removal of air from inside the cooking vessel 106 controls both the rate of fuel combustion and the cooking temperature inside the cooking vessel.

Although the example illustrated fan 114 comprises a centrifugal fan in a shaped volute 116 (collectively “fan assembly”), it should be appreciated that the implementations of the present disclosure are not limited to particular types of fans. As an example, in at least some implementations an axial-flow fan or other type of fan may be used. Further, in at least some implementations, multiple fans may be provided. For example, an exhaust fan may be provided to control the flow of gases through the fuel cartridge 104, and a circulation fan may be provided to circulate the air in the cooking temperature to maintain an even temperature throughout the volume of the cooking chamber.

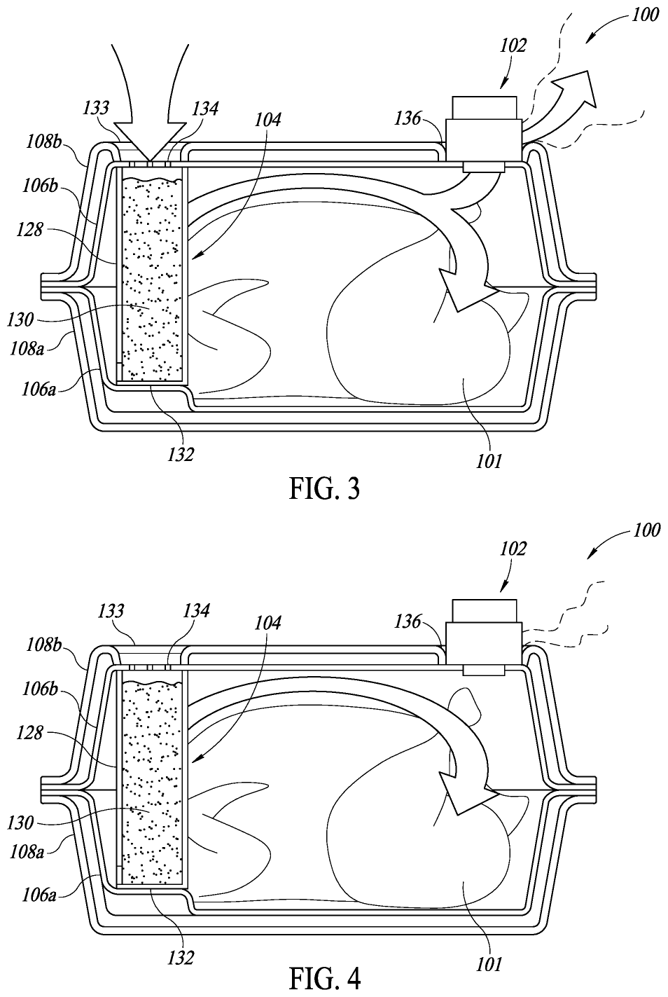

The combustible fuel-fired fuel cartridge 104 may comprise a container or can 128 of variable dimensions. The can 128 may be made of metal or other suitable material, and may in at least some implementations be recyclable or otherwise disposable. The can 128 contains one or more combustible materials 130 such as wood or charcoal pellets or chips, for example. The bottom 132 of the can 128 may be perforated to allow for the combustible materials 130 to be lit from the bottom of the can with, for example, a fire starter placed beneath the can and then for the fuel to burn from bottom up as shown in FIG. 3. In embodiments where the can is reusable, can may include an opening (e.g., removable lid) that allows the user to refill the can with additional combustible materials 130 (e.g., pellets, chips). In embodiments where the can 128 is disposable, the can may include a supply of combustible fuel 130 that may be used to cook food for a period of time (e.g., 4 hours, 12 hours, 20 hours, etc.). Various types of combustible fuels may be provided for user selection, such as wood pellets, compressed or extruded wood shapes (e.g., log), wood chips from various species (e.g., hickory, pecan, alder, cherry, blends, etc.), charcoal, other types of biomass, or any combination thereof (e.g., compressed or extruded sawdust combined with charcoal).

Advantageously, the fuel cartridge 104 is arranged in the cooking vessel such that we the fan 114 of the controller 102 is turned off or at a low-speed, the buoyant high-temperature combustion gases will flow in a direction through the fuel cartridge that causes them to be exhausted to the environment without travelling through the cooking vessel. In this way, the majority of heat generated by combustion is rejected and does not increase cooking temperature when the fan is turned off or is operating at a low-speed.

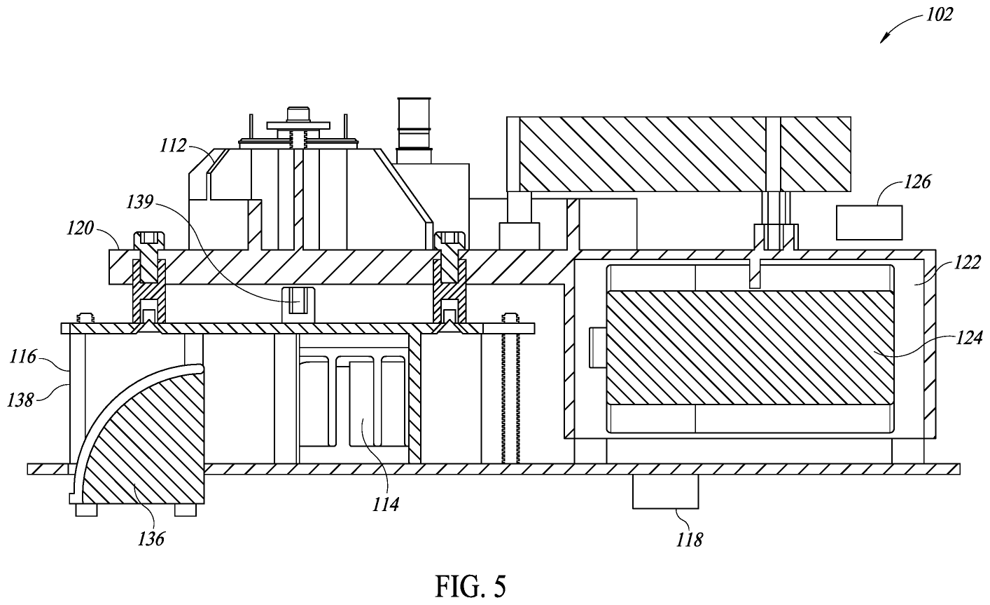

FIG. 4 shows the disposable smoke roasting device 100 when the fan 114 of the controller 102 is turned off or running slowly so that little air and smoke is exhausted from the cooking chamber of the cooking vessel 106 and no pressure drop occurs. The controller 102 may cause the fan 114 to continue to recirculate air inside the chamber at a low speed to maintain a uniform cooking temperature throughout the cooking chamber. The combusting fuel 130 draws smoke and air from the chamber in from the bottom 132 of the can 128 of the fuel cartridge 104. Because this air has a relatively low-oxygen content, the fire is stifled and begins to cool. Any combustion gases will escape from the top 134 of the can 128 and into the environment, bypassing the cooking chamber, so that the temperature begins to fall inside the cooking chamber of the cooking vessel 106. However, the high temperature inside the chamber keeps the fuel 130 (e.g., pellets) warm and ready to reignite as soon as they are exposed to fresh air.

But when the fan 114 is exhausting air from the cooking vessel 106 fast enough to create an adequate pressure drop inside the cooking vessel, then the flow of combustion gases through the can 128 will reverse, and flow against the natural direction favored by buoyant combustion gases. Fresh air will then enter the top 134 of the can 128 and provide oxygen to the smoldering or combusting fuel 130, increasing the rate of combustion and, thus, the temperature of combustion gases that will then exit the perforated bottom 132 of the can and mix with air inside the cooking vessel, thereby increasing the cooking temperature. Thus, by using input from one or more temperature sensors (e.g., temperature sensor(s) 118) and controlling the operation of the fan 114, the controller 102 and the fuel cartridge 104 design work together to allow for variable and precise temperature control of the system.

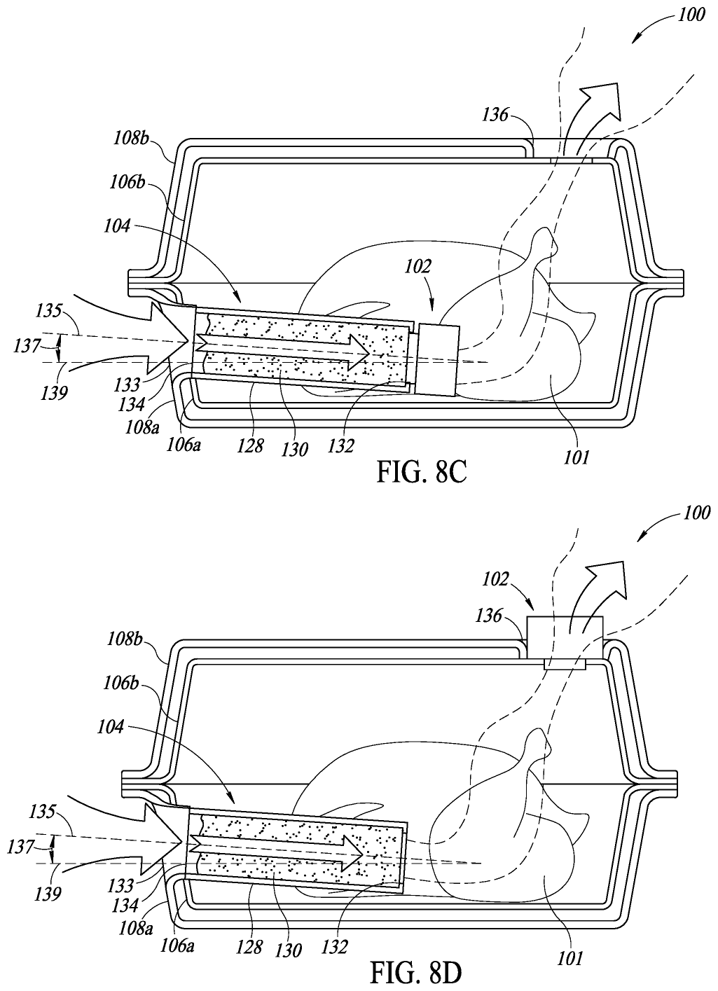

FIG. 3 shows the fan 114 running so that air and smoke are exhausted from the cooking chamber of the cooking vessel 106 fast enough to result in a pressure drop that inverts the direction of draft through the combustion chamber, drawing fresh air in from the top 134 of the fuel cartridge 104 and pulling hot combustion gases into the chamber from the bottom 132 of the can 128 beneath the combustible fuel 130. As discussed further below with reference to FIG. 7, in at least some implementations the fan 114 also recirculates a fraction of the air back into the cooking chamber of the cooking vessel 106. It is noted that in FIG. 3, although the arrow shows the split of air flow inside the cooking chamber before reaching the fan 114, in operation both exhaust and recirculation air may flow through the fan 114 before being split and directed in one of two directions, as discussed below.

Unlike other approaches to reversing the flow of combustion gases to control temperature inside a cooking vessel, the embodiments of the present disclosure have several distinct advantages that are derived from, among other things, locating the fuel cartridge 104 of fuel 130 inside the cooking vessel 106, rather than outside the vessel and connecting the fuel cartridge to the vessel via ducting.

First, when forward combustion prevails (i.e., airflow and exhaust are moving in the same direction as the consumption of fuel as shown in FIG. 4), air drawn into the bottom 132 of the can 128 is low-oxygen air. This air starves the combustion reaction of oxygen and the fuel 130 quickly settles into low-temperature smoldering. This greatly reduces the rate of fuel consumption.

Second, when the fan 114 is turned off or at low speed, combustion gases are vented to the outside directly, thereby bypassing the cooking chamber. When the fan 114 is running, however, high temperature combustion gases are drawn into the cooking chamber when the cooler chamber gases are exhausted.

Third, a much greater fraction of heat generated is used for cooking rather than lost as waste heat to the surrounding environment. This is because even when smoldering, a fraction of the generated heat is radiated and convected to the inside of the cooking vessel 106.

Fourth, keeping the fuel inside the cooking vessel 106 keeps the fuel 130 warm so that, even when starved of oxygen and smoldering, the fuel is primed to quickly reignite when fresh air is reintroduced.

While not required for the controller 102 and the combustible fuel-fired fuel cartridge 104 to operate as a system, at least some embodiments of the present disclosure use low-cost recyclable and/or compostable materials to form the cooking vessel 106 to provide a disposable cooking vessel. The example configuration shown in the Figures uses two stamped foil trays 106a (lower tray) and 106b (upper tray or lid) to contain the food 101. The cooking vessel 106 may be formed from aluminum or other suitable material, as discussed further below. The upper lid 106b contains at least one cut out 136 for the control unit 102 to sit over to draw air into the fan 114 of the controller and either recirculate it into the cooking vessel 106 or exhaust it to the ambient environment, as discussed above. The upper lid 106b also contains a second cut out 133 or perforated area above a top portion 134 of the fuel cartridge 104 for the fuel cartridge to draw fresh air in from the environment or exhaust combustion gases out to the environment.

The cooking vessel 106 may be designed such that when the upper lid 106b and the lower tray 106a are set onto one another, a relatively tight seal is formed so that when the control fan 114 is exhausting air from the cooking vessel, the preferred entry point for fresh air is down through the top 134 of the fuel cartridge 104.

In at least some implementations, the lower tray 106a is also designed with steps 137 (e.g., along a side wall) that can support one or more racks to create multiple shelves to support food 101 inside the cooking vessel 106.

The foil tray 106a may also be designed with features 135 that capture the bottom 132 of the fuel cartridge 104, with a well beneath the fuel cartridge to hold a fire-starter and to collect ash, to create a uniform reduced pressure field beneath the fuel inside the can for improved suction through the can, and to direct high-temperature exhaust exiting the fuel cartridge into a corner of the foil tray 106a, away from the food 101, so that these gases will mix with cooler air before reaching the food.

The foil tray 106a may be designed with features on the bottom to support food 101 above juices lost from the food and to allow the circulation of air and smoke beneath the food. The bottom of the foil tray 106a may also be shaped so that juices are directed towards the edges of the tray to keep the bottom of the food 101 dry during the cooking process.

In at least some implementations, the foil tray 106a may be designed with a shaped corner for a thermometer cable to enter the cooking vessel 106 without breaking the seal between the upper lid 106b and lower tray 106a. The disposable cooking vessel system 100 may be designed such that the lower and upper portions neatly nest inside one another for efficient packaging.

While the present embodiment describes an aluminum foil tray 106a and lid 106b that form the cooking vessel 106, in other embodiments this tray may be formed from steel or other alloys that can withstand higher temperatures and, thus, allow the device to be used as a disposable charcoal grill when combined with suitable ventilation holes and a grill rack sitting above the coals.

In still other embodiments, the inner metal tray may be made from heavier gauge metals to be reusable.

In at least some implementations, the outer shell 108 may be provided that contains the cooking vessel 106 to provide a double-walled insulated construction for a cool-to-the-touch outer surface and a reduced rate of fuel consumption. The outer shell 108 may include a lower shell 108a and an upper shell 108b, as a non-limiting example. This double-walled disposable construction also allows the cooking vessel 106 to function as a disposable cooler when transporting foods like meat to a cooking location (e.g., campground, tailgate party). In at least some embodiments, the outer shell 108 is made of renewable pulp-fiber construction treated with a non-toxic fire-retardant system such as borax and boric acid or other suitable system.

In at least some embodiments, the entire disposable cooking vessel 106 may be composed of a pulp-fiber shell that is treated with suitable fire retardants. In other embodiments, the cooking vessel 106 and/or the outer shell 108 may be made from one or more other disposable materials that are naturally fire-retardant such as felt or cork, or more durable and reusable materials such as metal, ceramic, wood, plastics, or combinations thereof.

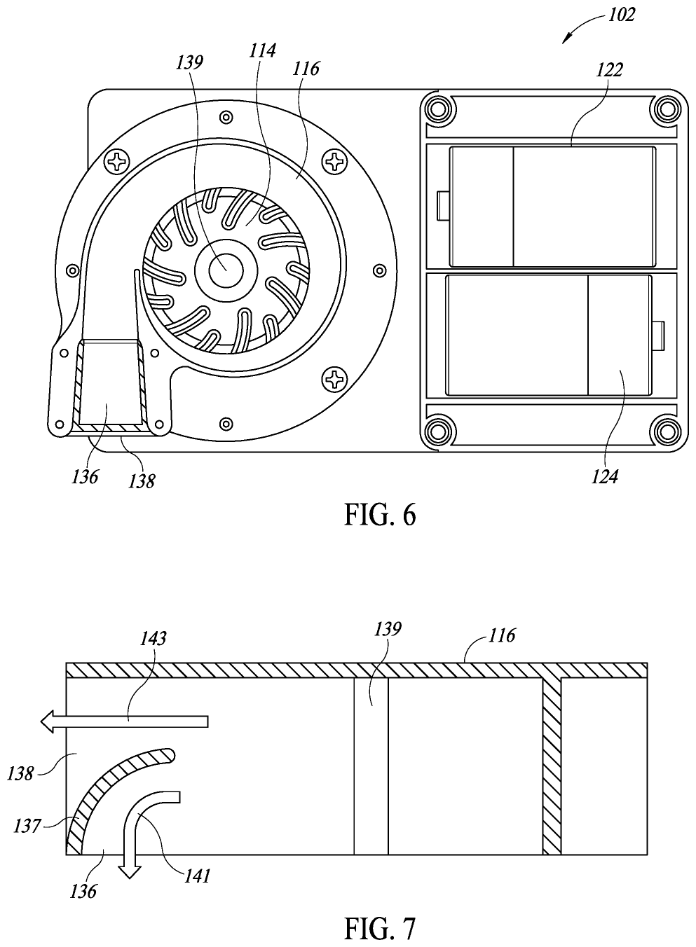

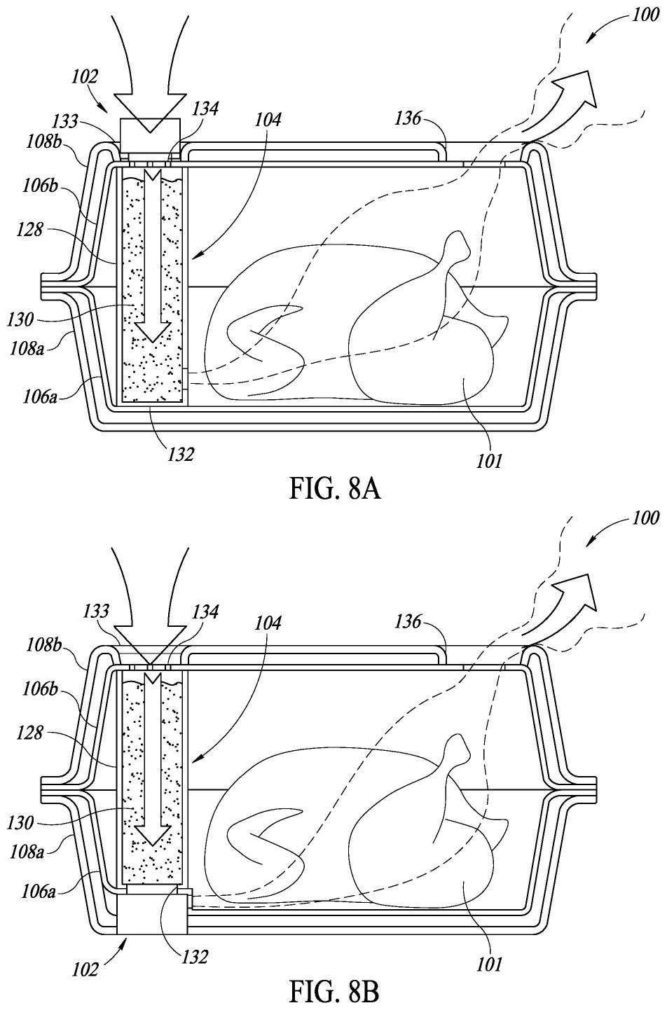

FIG. 5 is a sectional view of the control unit 102 of the disposable smoke roasting device 100 that shows the battery compartment 122, fan blade 114, fan housing 116, motor 112, and motor mount of the control unit. FIG. 6 is a bottom view of the control unit 102 showing the centrifugal fan blade 114 inside the volute housing 116 and the battery compartment 122 that houses the batteries 124. Air is drawn into the center of the fan 114, and moved to the outside of the fan blade and pushed around the spiral of the volute 116. A fraction of the air is expelled downward through a duct 136 back into the cooking chamber of the cooking vessel 106. Another fraction of the air exits the system by being pushed out sideways through a section 138 of the exit path (see FIG. 7). At low-speed the air flow will prefer to go through the downward facing ducting 136 and recirculate into the cooking chamber of the cooking vessel 106, but at high speeds this path will become choked and more air will flow out of the system through the section 138, dropping the overall pressure of the cooking chamber, which in turn inverts the draft through the fuel cartridge 104 as shown in FIG. 3.

FIG. 7 is a sectional view of a portion of the fan volute 116. The fan (not shown in FIG. 7) is centered around the shaft 139 (shown by two vertical black lines in FIG. 7). Air is compressed inside the volute 116 and must exit either downward along the arc portion 137 as shown by an arrow 141 (being redirected into the cooking vessel 106) or out of the system by flowing above the arc portion 137 as shown by the arrow 143. The exact position of the arc portion 137, the shape of the arc portion, and the speed of the fan 114 determines the fraction of air that travels one pathway or the other. Other constructions may be implemented. As a non-limiting example, a sprung flap valve may be provided that only opens to exhaust air when the exhaust air has enough pressure to do so. However, this design may be less desirable for some applications as it is more mechanically complicated, fragile, and may be prone to sticking as the parts become coated with residue from the smoke from combustion.

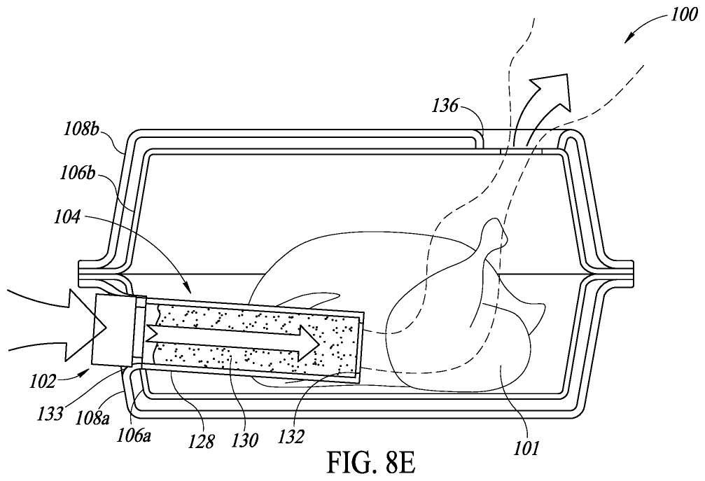

FIGS. 8A-8E are sectional views of the disposable smoke roasting device 100, illustrating various additional non-limiting example fuel cartridge configurations and fan configurations of the device. Another fuel cartridge and fan configuration is shown in FIGS. 3 and 4 and discussed above. For explanatory purposes, the same reference numbers have been used to represent identical or similar components in the drawings.

In FIGS. 8A-8E, there are two illustrated example fuel cartridge orientations, vertical and nearly horizontal (e.g., 1 to 10 degrees from horizontal). In practice, the fuel cartridge 104 may be oriented at any angle between horizontal (i.e., 0 degrees with respect to a horizontal axis) and vertical (i.e., 90 degrees with respect to a horizontal axis), including horizontal and vertical (e.g., FIGS. 3, 4, 8A and 8B). As discussed above, the container 128 of the fuel cartridge 104 includes a bottom portion 132, a top portion 134 opposite the bottom portion, and a sidewall that extends between the top portion and the bottom portion. As illustrated in FIG. 8C, the fuel cartridge 104 may be positionable inside the cooking vessel such that a central axis 135 that extends between the bottom portion 132 and the top portion 134 is oriented at an angle 137 that is between 0 degrees and 90 degrees from a horizontal axis 139. In at least some implementations, the central axis 135 is oriented at an angle 137 that is between 1 degree and 10 degrees, such as the implementations shown in FIGS. 8C-8E. By orienting the fuel cartridge 104 at a non-vertical position, such as the position shown in FIGS. 8C-8C, the fan 114 may require less power to overcome the natural direction of the flow of the buoyant combustion gases. Thus, the control unit may require less power for operation. Further, the fan may be lower in power, smaller, or less expensive than would otherwise be required.

The drawings also illustrate three non-limiting example fan configurations for each fuel cartridge orientation. In particular, FIGS. 8A and 8E show implementations wherein the control unit 102 including the fan 114 is positioned at the top portion 134 (fresh air inlet) of the fuel cartridge 104, and in operation the fan pushes fresh air into the fuel cartridge 104 when turned on. FIGS. 8B and 8C show implementations wherein the control unit 102 including the fan is positioned between the bottom portion 132 of the fuel cartridge 104 and the cooking vessel, wherein, when turned on, the fan pulls fresh air from the top portion or inlet 134 into the fuel cartridge 104 and pushes hot combustion gases into the cooking vessel through the bottom portion 132. FIGS. 3, 4 and 8D show implementations wherein the control unit 102 including the fan 114 is positioned on the cooking vessel at the opening 136 spaced apart from the fuel cartridge 104. When the fan 114 is turned on, the fan ejects gases from the cooking vessel, causing fresh air to be drawn into the fuel cartridge 104 via the top portion 134 and hot combustion gases to be drawn into the cooking vessel via the bottom portion 132 of the fuel cartridge.

FIG. 9 shows a system diagram that describes one implementation of computing systems for implementing embodiments described herein. As discussed elsewhere herein, the control unit 102 may be operative to receive temperature or other input, and to precisely control the cooking conditions inside the cooking vessel 106 to cook a food product 101 according to various control algorithms. The control unit 102 may dynamically modify the operation of the fan 114 based on various conditions (e.g., temperature, humidity) inside the cooking chamber, as measured by one or more sensors 118 of the control unit or one or more sensors communicatively coupled to the control unit. In various embodiments, the control unit 102 may utilize real-time data received from sensors, one or more external devices or accessories 162, and may use such data to provide real-time control of the cooking conditions in the cooking chamber and may also provide feedback to the user via a component of the control unit or via an external device. One or more special-purpose computing systems may be used to implement the control unit 102. Accordingly, various embodiments described herein may be implemented in software, hardware, firmware, or in some combination thereof. The control unit 102 may also include memory 140, one or more processors 148, display 150, other I/O interfaces 152, and communications interfaces 154.

Processor 148 includes one or more processing devices that execute computer instructions to perform actions, including at least some embodiments described herein. In various embodiments, the processor 148 may include one or more central processing units (“CPU”), programmable logic, or other processing or control circuitry.

Memory 140 may include one or more various types of non-volatile and/or volatile storage technologies. Examples of memory 140 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 140 may be utilized to store information, including computer-readable instructions that are utilized by processor 148 to perform actions, including embodiments described herein.

Memory 140 may have stored thereon control algorithms or programs 142 that implement the functionality discussed herein. The memory 140 may also store other programs 246 and other data 248 to provide various functionality for the control unit 102.

In at least some implementations, the control unit may include a display 150, which may be a display interface that is configured to output images, content, or information to a user, such as information regarding the cooking process (e.g., settings, current conditions, etc.). Examples of display 150 include, but are not limited to, LCD screens, LEDs or other lights, or other types of display devices. Other I/O interfaces 152 may include a keyboard, audio interfaces, video interfaces, or the like.

Communications interfaces 154 are configured to communicate with other computing devices via wired or wireless connections (e.g., over communication network 160). As an example, the communications interfaces 154 may allow the control unit 102 to communicate with one or more external devices or accessories 162, which may include temperature sensors, humidity sensors, mobile computing devices (e.g., smartphone, tablet computer), remote servers, etc. The communications interfaces 154 may include one or more wired interfaces (e.g., USB®), and/or wireless interfaces (e.g., Bluetooth®).

As a non-limiting example, an accessory may include a multi-point thermometer 164 that is communicatively coupleable to the control unit via a wired interface (e.g., USB®) or a wireless interface (e.g., Bluetooth®). The multi-point thermometer 164 may include a plurality of temperature sensors 166. In the illustrated embodiment, the thermometer 164 includes a cooking chamber sensor 166a, a food surface sensor 166b, and an internal food sensor 166c. As shown schematically in FIG. 9, the user may insert the thermometer 164 into the food product 101 such that the cooking chamber sensor 166a is positioned outside of the food product 101 inside the cooking chamber of the cooking vessel 106, the food surface sensor 166b is positioned at the surface 103 of the food product 101, and the internal food sensor 166c is positioned within the food product.

Thus, using the thermometer 164, the control unit 102 may simultaneously receive temperature data inside the food product 101, at the surface 103 of the food product, and within the cooking chamber of the cooking vessel 106. The control unit 102 may utilize such data to optimally control the cooking conditions inside the cooking chamber. As an example, the temperature at the surface 103 of the food product 101 is the actual cooking temperature for the food product (which is at or below the chamber temperature due to evaporative cooling of the food) so such information can be used to precisely control this cooking temperature. Further, if the control unit 102 determines that the internal temperature of the food product 101 is well below the desired temperature, the control unit 102 may increase the temperature of the cooking chamber for a duration of time until the internal temperature is closer to the desired temperature, at which time the control unit may decrease the temperature of the cooking chamber to complete the cooking process at a more controlled rate. By obtaining temperature data at the surface of the food product 101, the control unit 102 can also ensure that the cooking temperature that the food product is exposed to is maintained at a desired temperature or range of temperatures.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

This application claims priority to U.S. Provisional Application No. 63/068,822 filed Aug. 21, 2020, the contents of which are incorporated by reference herein in their entirety.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A cooking device, comprising:
a cooking vessel that is sized and dimensioned to receive a food product;
a fuel cartridge positionable within the cooking vessel that contains a supply of combustible fuel; and
a control unit that comprises:
a fan;
a temperature sensor; and
control circuitry operatively coupled to the fan and the temperature sensor, wherein in operation, the control circuitry receives temperature information from the temperature sensor and dynamically modifies the operation of the fan based at least in part on the received temperature information to selectively control the cooking conditions within the cooking vessel to cook the food product.

2. The cooking device of claim 1, wherein at least one of the cooking vessel and the fuel cartridge are disposable.

3. The cooking device of claim 1, wherein the fan is configured to eject air from within the cooking vessel, causing a pressure drop that draws fresh air through the fuel cartridge containing the combustible fuel, increasing the rate of combustion, and causing high temperature combustion gases from the burning combustible fuel to flow into the cooking vessel, wherein the temperature rise in the cooking vessel is determined by the speed of the fan and a duration of operation of the fan.

4. The cooking device of claim 1, wherein, when turned on, the fan is configured to create a pressure increase that pushes fresh air through the fuel cartridge containing the combustible fuel, increasing the rate of combustion, which causes high temperature combustion gases from the burning combustible fuel to flow into the cooking vessel, wherein the temperature rise in the cooking vessel is determined by the speed of the fan and a duration of the operation of the fan.

5. The cooking device of claim 1, wherein, when turned on, the fan is configured to cause a pressure drop that pulls fresh air into the fuel cartridge containing the combustible fuel, which causes high temperature combustion gases from the burning combustible fuel to flow into the cooking vessel, causing a pressure rise that forces relatively cooler air to exit the cooking vessel, wherein the result is a temperature rise in the cooking vessel.

6. The cooking device of claim 1, wherein, when turned off or at low speed, the fan is configured to allow high temperature combustion gases from the burning combustible fuel to flow back through the fuel cartridge and exhaust to the ambient environment without entering the cooking vessel.

7. The cooking device of claim 1, wherein the control circuitry receives a set-point temperature as input, and the control circuitry modifies the operation of the fan based at least in part on the received set-point temperature and the received temperature information to maintain the temperature within the cooking vessel at the set-point temperature.

8. The cooking device of claim 1, wherein the fuel cartridge comprises a container that houses the supply of combustible fuel, the container comprising a bottom portion that includes a plurality of openings which allow airflow, and a top portion that includes a plurality of openings which allow airflow.

9. The cooking device of claim 1, wherein the fuel cartridge comprises a container that houses the supply of combustible fuel, the container comprising a bottom portion, a top portion opposite the bottom portion, and a sidewall that extends between the top portion and the bottom portion, wherein the fuel cartridge is positionable inside the cooking vessel such that a central axis that extends between the bottom portion and the top portion is oriented at a non-vertical angle.

10. The cooking device of claim 1, wherein the fuel cartridge comprises a container that houses the supply of combustible fuel, the container comprising a bottom portion, a top portion opposite the bottom portion, and a sidewall that extends between the top portion and the bottom portion, wherein the fuel cartridge is positionable inside the cooking vessel such that a central axis that extends between the bottom portion and the top portion is oriented at an angle that is between 1 degree and 10 degrees from horizontal.

11. The cooking device of claim 1, wherein the cooking vessel is formed from at least one of aluminum, steel, or an alloy.

12. The cooking device of claim 1, wherein the cooking vessel is formed from pulp-fiber material.

13. The cooking device of claim 1, further comprising an outer shell that is sized and dimensioned to contain the cooking vessel.

14. The cooking device of claim 13, wherein the outer shell is formed from pulp-fiber material, felt, cork, metal, ceramic, wood, or plastic.

15. The cooking device of claim 1, wherein the cooking vessel includes a first opening that selectively receives the control unit, and a second opening that is positioned above a top portion of the fuel cartridge.

16. The cooking device of claim 1, wherein the control unit is selectively communicatively coupleable to one or more accessories or external devices via a wired or wireless communications interface.

17. The cooking device of claim 16, wherein the one or more accessories comprise a multi-point thermometer that includes spaced-apart temperature sensors that are operative to simultaneously measure the temperature within the cooking vessel, at the surface of the food product, and within the food product.

18. A cooking device, comprising:
a cooking vessel that is sized and dimensioned to receive a food product;
a fuel cartridge positionable within the cooking vessel that contains a supply of combustible fuel, the fuel cartridge comprising an upper portion and a lower portion spaced apart from the upper portion; and
a control unit that comprises:
a fan configured to selectively control the flow of air through the fuel cartridge;
a temperature sensor; and
control circuitry operatively coupled to the fan and the temperature sensor, wherein in operation, the control circuitry receives temperature information from the temperature sensor and dynamically modifies the operation of the fan based at least in part on the received temperature information to selectively control the cooking conditions within the cooking vessel to cook the food product.

19. The cooking device of claim 18, wherein the fan is positioned proximate an opening of the cooking vessel and spaced apart from the fuel cartridge.

20. The cooking device of claim 18 wherein the fan is positioned substantially adjacent the upper portion of the fuel cartridge.

21. The cooking device of claim 18 wherein the fan is positioned substantially adjacent the lower portion of the fuel cartridge.

22. The cooking device of claim 18 wherein the fuel cartridge is positionable within the cooking vessel such that the upper portion of the fuel cartridge is not vertically aligned with the lower portion of the fuel cartridge.
